(19) United States
(12) Patent Application Publication
(10) Pub. No.: US 2015/0092329 A1
(43) Pub. Date: Apr. 2, 2015

(54) ELECTRONIC DEVICE SYSTEM WITH AN EMBEDDED DISPLAY UNIT

(71) Applicants: Sai P. Balasundaram, Beaverton, OR (US); MD Ruhul Quddus, Portland, OR (US); Sandeep R. Nair, Hillsboro, OR (US); Prosenjit Ghosh, Portland, OR (US)

(72) Inventors: Sai P. Balasundaram, Beaverton, OR (US); MD Ruhul Quddus, Portland, OR (US); Sandeep R. Nair, Hillsboro, OR (US); Prosenjit Ghosh, Portland, OR (US)

(21) Appl. No.: 14/040,668

(22) Filed: Sep. 28, 2013

(51) Int. Cl. G06F 1/16

(52) U.S. Cl. CPC G06F 1/165
USPC 361/679.09; 361/679.3; 361/679.27

(57) ABSTRACT

Particular embodiments described herein provide for an electronic device, such as a notebook computer, laptop, or tablet that includes a circuit board coupled to a plurality of electronic components (which may include any type of components, elements, circuitry, etc.). One particular example implementation of an electronic device may include a display portion, which includes a main display that is provided on a first side of the display portion; a secondary display unit that is provided on a second side of the display portion; and a hinge to secure the secondary display unit to the display portion, where the hinge is to allow a rotation of the secondary display unit in relation to the display portion.

### TECHNICAL FIELD

Embodiments described herein generally relate to an embedded display unit for an electronic device.

### BACKGROUND

End users have more electronic device choices than ever before. A number of prominent technological trends are currently afoot (e.g., more computing devices, duel displays, more detachable displays, etc.), and these trends are changing the electronic device landscape. One of the technological trends is an electronic device with two displays where one display is a main display and the other display is a small screen flat on the chassis or shell of the electronic device. When the electronic device is in a closed clamshell configuration, to access either display at a comfortable angle and use the electronic device, the electronic device needs to be opened. Hence, there is a challenge in providing access to use and interact with the electronic device without having to open the electronic device from a closed clamshell configuration.

Another of the technological trends is a convertible or hybrid laptop. The convertible laptop is any type of computer system that has a detachable display and can essentially function as either a laptop or a tablet computer. In some instances, once the display is detached, some users discover that the display can be heavy and the size of the display can be prohibitive from using as a tablet. Hence, there is a challenge in providing an electronic device that allows a display to be detached from the electronic device and then used as a tablet or a standalone device.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified orthographic view illustrating an embodiment of an electronic device, in accordance with one embodiment of the present disclosure;

FIG. 1B is a simplified orthographic view illustrating an embodiment of an electronic device, in accordance with one embodiment of the present disclosure;

FIG. 1C is a simplified orthographic view illustrating an embodiment of an electronic device, in accordance with one embodiment of the present disclosure;

FIG. 1D is a simplified orthographic view illustrating an embodiment of an electronic device, in accordance with one embodiment of the present disclosure;

FIG. 1E is a simplified orthographic view illustrating an embodiment of an electronic device in accordance with one embodiment of the present disclosure;

FIG. 2 is a simplified block diagram illustrating an embodiment of an electronic device in accordance with one embodiment of the present disclosure;

FIG. 3A is a simplified orthographic view illustrating an embodiment of an electronic device, in accordance with one embodiment of the present disclosure;

FIG. 3B is a simplified orthographic view illustrating an embodiment of an electronic device, in accordance with one embodiment of the present disclosure;

FIG. 3C is a simplified orthographic view illustrating an embodiment of an electronic device, in accordance with one embodiment of the present disclosure;

FIG. 4 is a simplified block diagram illustrating an embodiment of an electronic device, in accordance with one embodiment of the present disclosure;

FIG. 5A is a simplified orthographic view illustrating an embodiment of an electronic device, in accordance with one embodiment of the present disclosure;

FIG. 5B is a simplified orthographic view illustrating an embodiment of an electronic device, in accordance with one embodiment of the present disclosure;

FIG. 5C is a simplified orthographic view illustrating an embodiment of an electronic device, in accordance with one embodiment of the present disclosure;

FIG. 6 is a simplified block diagram illustrating an embodiment of an electronic device, in accordance with one embodiment of the present disclosure

FIG. 7 is a simplified block diagram associated with an example ARM ecosystem system on chip (SOC) of the present disclosure; and

FIG. 8 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Overview

Particular embodiments described herein provide for an electronic device, such as a notebook computer, laptop, or tablet that includes a circuit board coupled to a plurality of electronic components (which may include any type of components, elements, circuitry, etc.). One particular example implementation of an electronic device may include a display portion, which includes a main display that is provided on a first side of the display portion; a secondary display unit that is provided on a second side of the display portion; and a hinge to secure the secondary display unit to the display portion, where the hinge is to allow a rotation of the secondary display unit in relation to the display portion. Note that, in at least one embodiment, the configuration is reversed such that the secondary display unit is provided on any appropriate side of the keyboard portion of the electronic device.

In certain embodiments, the electronic device is configured to operate in a closed clamshell configuration in which the main display is not accessible and the secondary display unit is accessible. The secondary display unit can be configured for detachment from the display portion. The secondary display unit can operate as a standalone tablet when detached from the display portion. In other embodiments, the secondary display unit includes wireless communication circuitry, and the secondary display unit is configured to communicate with the display portion using the wireless communication circuitry when detached from the display portion. In yet other embodiments, the secondary display unit displays an image that is also provided on the main display. In at least one embodiment, the hinge includes an interconnect for transmitting a plurality of electrical signals, and the secondary display unit is connected to the display portion through the interconnect.

### Example Embodiments

The following detailed description sets forth example embodiments of apparatuses, methods, and systems relating to detachable unit configurations for an electronic device. Features such as structure(s), function(s), and/or characteristic(s), for example, are described with reference to one embodiment as a matter of convenience; various embodiments may be implemented with any suitable one or more of the described features.

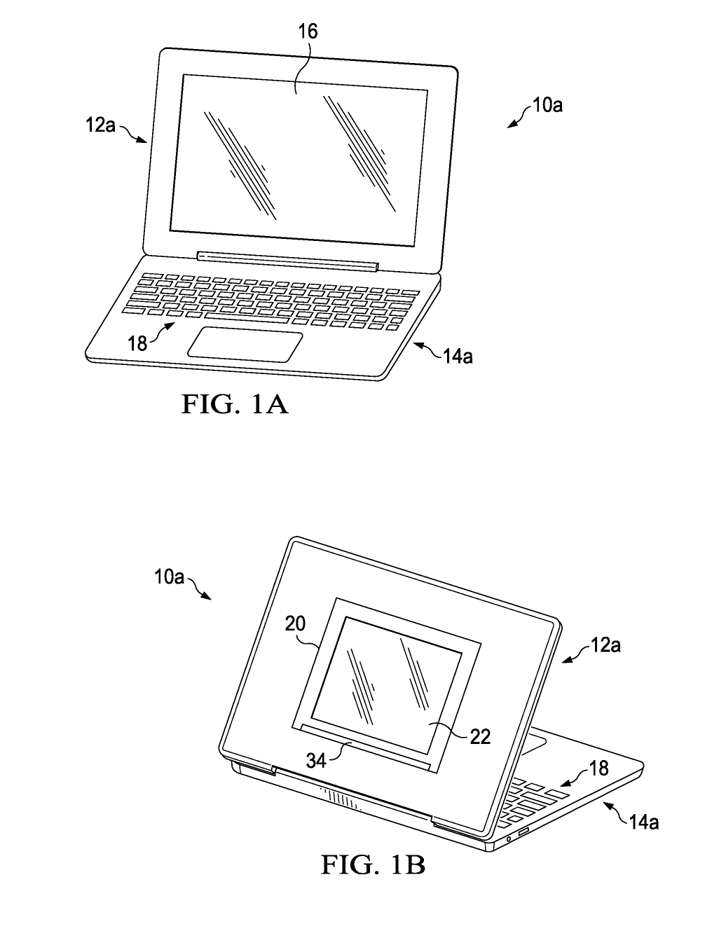

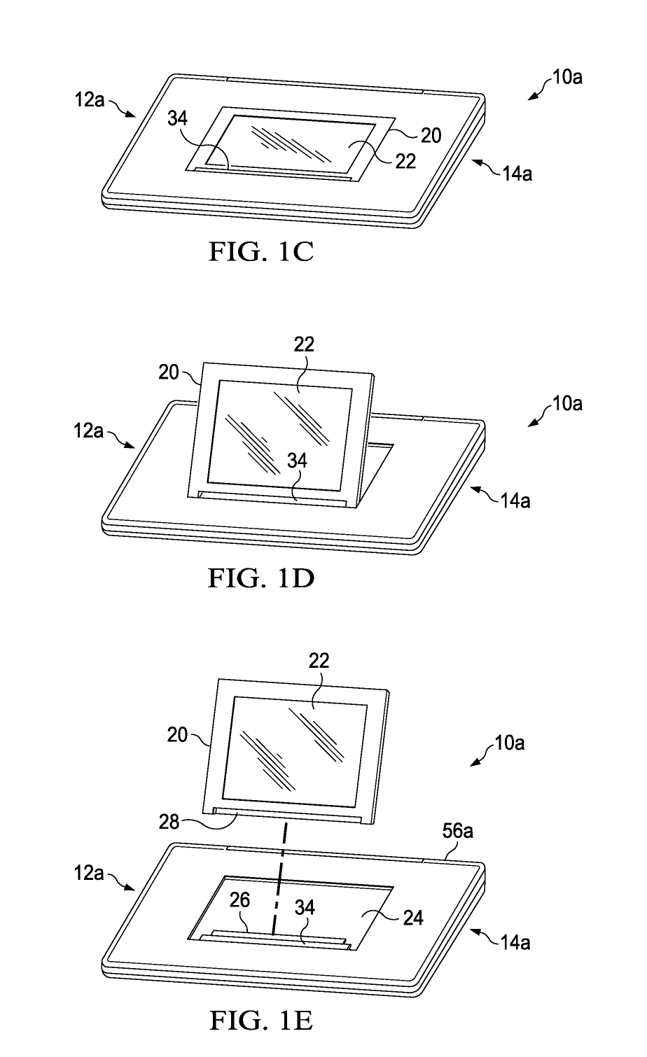

FIG. 1A is a simplified orthographic view illustrating an embodiment of an electronic device 10a in an open clamshell mode configuration in accordance with one embodiment of the present disclosure. Electronic device 10a may include a display portion 12a and a keyboard portion 14a. Display portion 12a can include a main display 16. Keyboard portion 14a can include a keyboard 18.

In one or more embodiments, electronic device 10a (and 10b and 10c discussed below) is a notebook computer or laptop computer. In still other embodiments, electronic device 10a (and 10b and 10c discussed below) may be any suitable electronic device having a display such as a mobile device, a tablet computer and/or a tablet device (e.g., i-Pad™), Phablet™, a personal digital assistant (PDA), a smartphone, an audio system, a movie player of any type, a computer docking station, etc. In yet another embodiment, most of the electronics (e.g., processor, memory, etc.) for electronic device 10a reside in keyboard portion 14a. Main display 16 can be a liquid crystal display (LCD), organic light-emitting diode (OLED), or some other type of display. Main display 16 may also be a touchscreen display. In an embodiment, electronic device 10a may contain a camera, a microphone, and speakers.

Turning to FIG. 1B, FIG. 1B is a simplified orthographic view illustrating an embodiment of an electronic device 10a in accordance with one embodiment of the present disclosure. Electronic device 10a may include display portion 12a and keyboard portion 14a. Display portion 12a may include a secondary display unit 20 and a hinge 34. Secondary display unit 20 may include a secondary display 22. Hinge 34 can facilitate an electrical and physical connection of secondary display unit 20 to display portion 12a. In an embodiment, hinge 34 can define an axis of rotation that is shared between display portion 12a and secondary display unit 20. Secondary display unit 20 can allow a user to use (i.e., access, interact with, interface with, work on, etc.) electronic device 10a. Using hinge 34, secondary display unit 20 can be rotated away from display portion 12a which can allow a more comfortable angle for viewing and interacting with secondary display unit 20 than just a small screen flat on the chassis or shell of electronic device 10a.

Secondary display 22 can be a liquid crystal display (LCD), organic light-emitting diode (OLED), or some other type of display. In an embodiment, secondary display unit 20 may contain a battery and various electronics (e.g., processor, memory, etc.) to allow secondary display unit 20 to operate as a standalone tablet or a handheld device. Secondary display 22 may also be a touchscreen display. When secondary display unit 20 is connected to display portion 12a, secondary display 22 can display images displayed or shown on main display 16, images that are complimentary to images displayed on main display 16, or can display images independently of main display 16.

Note that, although in certain embodiments electronic device 10a is configured to operate in a closed configuration in which the main display is not accessible and secondary display unit 20 is accessible, other embodiments account for various different configurations. Consider an example in which a user is able to check email sitting on a train using secondary display unit 20, while electronic device 10a (e.g., a laptop) is closed. In other embodiments, the primary and secondary screens can readily be used at the same time. For example, if a user is presenting to someone across from the user (at a table, in a coffee shop, etc.), the user can turn the electronic device (e.g., a laptop) such that the main screen faces the counterparty, and the user presenting could see what the counterparty sees by using the small screen display of secondary display unit 20. Further, the presenter/user can control the big screen view and one or more interactions from the small screen of secondary display unit 20.

Note also that the secondary screen of secondary display unit 20 can both operate as a secondary screen that is independent from the primary screen (showing different content, having different functionality, having different applications, etc.), or secondary display unit 20 can have similar characteristics. In addition, the secondary screen of secondary display unit 20 can operate as a replacement screen that operates instead of (or in conjunction with) the first screen using the same content and functionality.

Turning to FIG. 1C, FIG. 1C is a simplified orthographic view illustrating an embodiment of an electronic device 10a in accordance with one embodiment of the present disclosure. As illustrated in FIG. 1C, electronic device 10a is in a close clamshell configuration and secondary display unit 20 is flat on the chassis or shell of electronic device 10a. Main display 16 is not accessible.

Turning to FIG. 1D, FIG. 1D is a simplified orthographic view illustrating an embodiment of an electronic device 10a in a closed clamshell configuration in accordance with one embodiment of the present disclosure. When electronic device 10a is in a closed clamshell configuration, the user does not have access to main screen 16. As illustrated in FIG. 1D, secondary display unit 20 has been rotated about hinge 34 and away from display portion 12a. This allows the user to use secondary display unit 20 at a more comfortable angle than just flat on the chassis or shell to access and interact with electronic device 10a when electronic device 10a is in a closed clamshell configuration. In at least one embodiment, the hinge (operating in conjunction with any type of spring-loaded mechanism, magnet system, etc.) can facilitate a preset angle of the secondary display unit for viewing (e.g., a comfortable angle for viewing from the perspective of the user) upon receiving a downward force on any portion of the electronic device (e.g., a surface of the secondary display unit). Other embodiments could include a simple latch mechanism, or any suitable release that would assist in raising the secondary display unit to a suitable level.

Turning to FIG. 1E, FIG. 1E is a simplified schematic diagram illustrating an embodiment of electronic device 10a in a detach mode, separated into two segments. As illustrated in FIG. 1E, secondary display unit 20 has been separated from display portion 12a, creating a base device 56a and leaving a secondary display unit cavity 24 in display portion 12a. Secondary display unit cavity 24 can help hold or secure secondary display unit 20 to display portion 12a. Hinge 34 may include a display interconnect 26. Secondary display unit 20 may include a secondary display unit interconnect 28. Display interconnect 26 may be a printed circuit board (PCB) interconnector.

Using display interconnect 26, when secondary display unit 20 is connected to display portion 12a, an electrical current and signals can be passed between display portion 12a and secondary display unit 20 to recharge an on-board battery or capacitor, power any number of items (e.g., secondary display 22, wireless communication circuitry such as a wireless module, a camera, speakers, etc.), and provide a communication path between display portion 12a and secondary display unit 20. In other examples, electrical current and signals can be passed through a plug-in connector (e.g., whose male side protrusion connects to display portion 12a and whose female side connects to secondary display unit 20 or vice-verse) or a wireless connector (e.g., WiFi, Bluetooth, Wireless Display (WiDi), etc.). Note that any number of connectors (e.g., Universal Serial Bus (USB) connectors (e.g., in compliance with the USB 3.0 Specification released in November 2008), Thunderbolt™ connectors, a non-standard connection point such as a docking connector, etc.) can be provisioned in conjunction with electronic device 10a. [Thunderbolt™ and the Thunderbolt logo are trademarks of Intel Corporation in the U.S. and/or other countries.]. Virtually any other electrical connection methods could be used and, thus, are clearly within the scope of the present disclosure

In general terms, when electronic device 10a is in a closed clamshell configuration, hinge 34 can be used to rotate secondary display unit 20 away from display portion 12a which would allow a user to use or access electronic device 10a without opening up electronic device 10a. When secondary display unit 20 is removed from display portion 12a, secondary display unit 20 can function as a computer (e.g., notebook computer, laptop, tablet computer or device), phablet, a cellphone, a personal digital assistant (PDA), a smartphone, an audio system, a movie player of any type, or other device that includes a circuit board coupled to a plurality of electronic components (which includes any type of components, elements, circuitry, etc.). Secondary display unit 20 can include a battery and various electronics (e.g., processor, memory, etc.) to allow secondary display unit 20 to function as a standalone device. In another embodiment, secondary display unit 20 may include a camera, a microphone, and speakers. In yet another embodiment, secondary display unit 20 may include very little computing and/or storage components so secondary display unit 20 can be really thin with a battery occupying almost the entire area of secondary display unit 20. When secondary display unit 20 is separated from display portion 12a, secondary display 22 can display images shown on main display 16, images that are complementary to images shown on main display 16, or can display images independently of main display 16.

For purposes of illustrating certain example features of electronic devices 10a, 10b, and 10c, the following foundational information may be viewed as a basis from which the present disclosure may be properly explained. Some form factors for clamshell computer include a second display on the outside of a chassis or shell of the clamshell computer where the second display is located on the opposite side of a main display. However, the secondary display is completely integrated and fused to the chassis or shell and a user has to hold the clamshell computer to interact with the secondary display. In at least one example embodiment discussed herein, a hinge can be used to rotate secondary display unit away from the chassis or shell of the clamshell computer which would allow a user to use or access the secondary display and the clamshell computer without opening up the clamshell computer from a closed clamshell configuration.

In addition, with the recent touch optimized operating system (OS) release for tablets, convertible laptops have become more popular. The convertible laptops can be configured such that the entire display can be unhinged and removed from the base or keyboard portion of the convertible laptop. However, after the display is removed and is in a tablet configuration, the display can be heavy and the size of the display can be prohibitive from using as a tablet. If the display were smaller to accommodate use in the tablet configuration, then when the display is reattached to the base or keyboard portion to create a clamshell configuration, the display may be too small to use as a display in the clamshell configuration. In at least one example embodiment discussed herein, an electrical device can be configured to allow a secondary display of the electronic device to be removable. The secondary display can be separate from the main display and, further, be configured to operate as a standalone tablet or a handheld device.

Particular embodiments described herein provide for an electronic device, such as a notebook computer, laptop, cellphone, or other mobile device that includes a circuit board coupled to a plurality of electronic components (which includes any type of components, elements, circuitry, etc.). The electronic device may also include a secondary display unit (that includes a secondary display) which can be docked, attached, or connected to the electronic device using a hinge. When docked or connected, the secondary display unit can be flush with the surface of the electronic device so the electronic device looks and functions like a dual display electronic device. In addition, using the hinge, the secondary display unit may be raised up or rotated outward from the electronic device to an angle that allows a user to interact with the secondary display unit. For example, if the user has the electronic device in a closed clamshell configuration, the display unit can be raised at an angle to allow the user to view and interact with the detachable display.

In addition, the secondary display unit can be undocked, detached, or removed from the electronic device and the secondary display unit can function or operate like tablet or handheld electronic device. In an embodiment, the secondary display unit may include just a display, a battery, wireless capability, and only the necessary electronics for the secondary display unit to function as a standalone tablet or handheld device. The secondary display unit may use WiFi, Bluetooth, WiDi, etc. to communicate with a network or other electronic devices. The size of the secondary display unit is only limited by functionality (e.g., too small and the detachable display may not function as a standalone device) and the size of the electronic device (e.g., the detachable display may not be bigger than the electronic device). For example, the size of the secondary display unit can vary anywhere from the size of a small digital music player up to the size of the chassis or main body of electronic device.

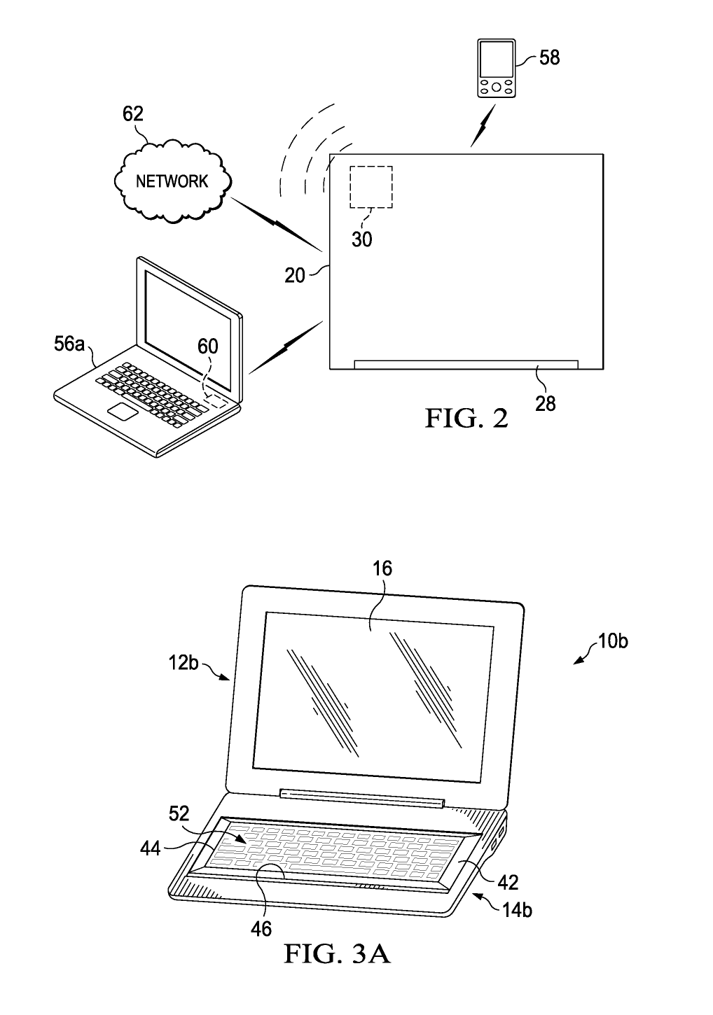

Turning to FIG. 2, FIG. 2 is a simplified block diagram illustrating an embodiment of electronic device 10a in accordance with one embodiment of the present disclosure. Secondary display unit 20 may include secondary display unit interconnect 28 and a wireless module 30. Wireless module 30 (e.g., Wi-Fi module, Bluetooth module, WiDi module, or other wireless communication circuitry) allows secondary display unit 20 to communicate with base device 56a when secondary display unit 20 is removed from display portion 12a. Base device 56a can contain base wireless module 60. Wireless module 30 may also allow secondary display unit 20 to communicate with a network 62 and a second electronic device 58 through a wireless connection.

The wireless connection may be any 3G/4G/LTE cellular wireless, WiFi/WiMAX connection, WiDi connection, or some other similar wireless connection. In an embodiment, the wireless connection may be a wireless personal area network (WPAN) to interconnect secondary display unit 20 to base device 56a, network 62, or second electronic device 58 within a relatively small area (e.g., Bluetooth™, invisible infrared light, Wi-Fi, WiDi, etc.). In another embodiment, the wireless connection may be a wireless local area network (WLAN) that links secondary display unit 20 to base device 56a, network 62, or second electronic device 58 over a relatively short distance using a wireless distribution method, usually providing a connection through an access point for Internet access. The use of spread-spectrum or OFDM technologies may allow secondary display unit 20 to move around within a local coverage area, and still remain connected to base device 56a, network 62, or second electronic device 58.

Network 62 may be a series of points or nodes of interconnected communication paths for receiving and transmitting packets of information that propagate through network 62. Network 62 offers a communicative interface and may be any local area network (LAN), wireless local area network (WLAN), metropolitan area network (MAN), Intranet, Extranet, WAN, virtual private network (VPN), or any other appropriate architecture or system that facilitates communications in a network environment. Network 62 can comprise any number of hardware or software elements coupled to (and in communication with) each other through a communications medium. Second electronic device 58 may be a computer (e.g., notebook computer, laptop, tablet computer or device), a phablet, a cellphone, a personal digital assistant (PDA), a smartphone, an audio system, a movie player of any type, router, access point, or other device that includes a circuit board coupled to a plurality of electronic components (which includes any type of components, elements, circuitry, etc.).

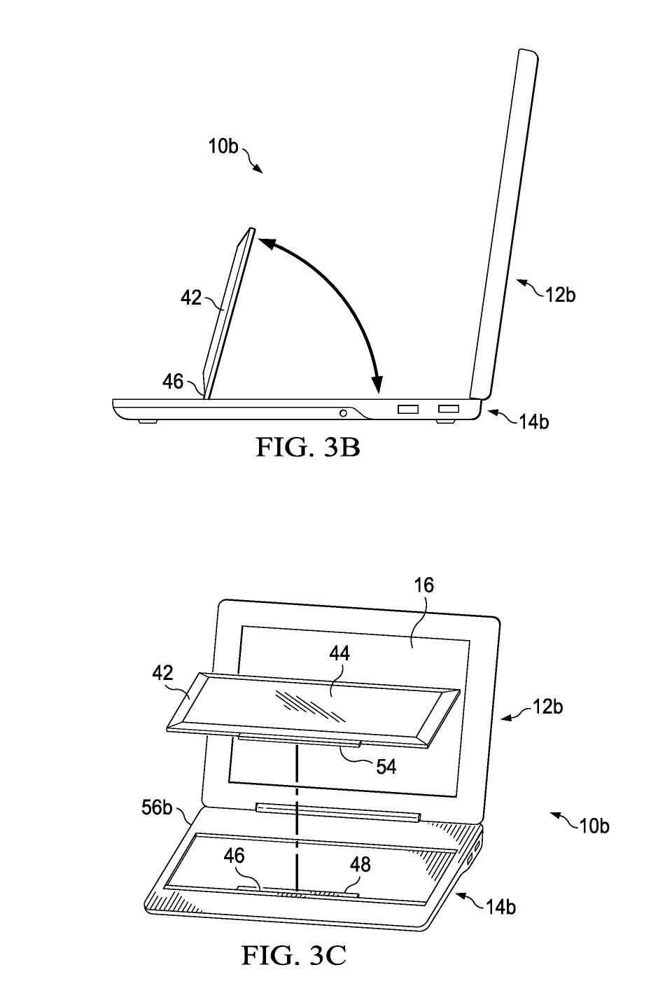

Turning to FIG. 3A, FIG. 3A is a simplified orthographic view illustrating an embodiment of an electronic device 10b in accordance with one embodiment of the present disclosure. Electronic device 10b may include a display portion 12b and a keyboard portion 14b. Display portion 12b is different than display portion 12a in that display portion 12b does not include secondary display unit 20 and hinge 34. Keyboard portion 14b can include a detachable keyboard unit 42 and a keyboard hinge 46. Keyboard hinge 46 can define an axis of rotation that is shared between keyboard portion 14b and detachable keyboard unit 42. Detachable keyboard unit 42 may include a keyboard display 44. Keyboard display 44 can be a liquid crystal display (LCD), organic light-emitting diode (OLED), or some other type of display. Keyboard display 44 may also be a touchscreen display. In an embodiment, detachable keyboard unit 42 may contain a battery and various electronics (e.g., processor, memory, etc.) to allow detachable keyboard unit 42 to operate as a standalone tablet. In an embodiment, when detachable keyboard unit 42 is connected to keyboard portion 14b, keyboard display 44 may display an interactive virtual keyboard 52.

Turning to FIG. 3B, FIG. 3B is a simplified orthographic view illustrating an embodiment of an electronic device 10b in accordance with one embodiment of the present disclosure. As illustrated in FIG. 3B, detachable keyboard unit 42 has been rotated about keyboard hinge 46 and away from keyboard portion 14b. Turning to FIG. 3C, FIG. 3C is a simplified schematic diagram illustrating an embodiment of electronic device 10b in a detached mode, separated into two segments. As illustrated in FIG. 3C, detachable keyboard unit 42 has been separated from keyboard portion 14b, creating a base device 56b. Keyboard hinge 46 may include a keyboard interconnect 48. Detachable keyboard unit 42 may include a detachable keyboard unit interconnect 54. Keyboard interconnect 48 may be a PCB interconnector.

Using keyboard interconnect 48, an electrical current and signals can be passed between keyboard portion 14b and detachable keyboard unit 42 to recharge an on-board battery or capacitor, power any number of items (e.g., keyboard display 44, a wireless module, a camera, speakers, etc.), and provide a communication path between keyboard portion 14b and detachable keyboard unit 42. In other examples, electrical current and signals can be passed through a plug-in connector (e.g., whose male side protrusion connects to keyboard portion 14b and whose female side connects to detachable keyboard unit 42 or vice-verse) or a wireless connector (e.g., WiFi, Bluetooth, WiDi, etc.).

In one or more embodiments, when removed from keyboard portion 14b, detachable keyboard unit 42 can function as a computer (e.g., notebook computer, laptop, tablet computer or device), a phablet, a cellphone, a personal digital assistant (PDA), a smartphone, an audio system, a movie player of any type, or other device that includes a circuit board coupled to a plurality of electronic components (which includes any type of components, elements, circuitry, etc.). Detachable keyboard unit 42 can include a battery and various electronics (e.g., processor, memory, etc.) to allow detachable keyboard unit 42 to function as a standalone device. In yet another embodiment, detachable keyboard unit 42 may include a camera, a microphone, and speakers. When detachable keyboard unit 42 is removed from keyboard portion 14b, keyboard display 44 may display interactive keyboard 52 (shown in FIG. 3A). In another embodiment, when detachable keyboard unit 42 is removed from keyboard portion 14b, detachable keyboard unit 42 may function as a standalone tablet and keyboard display 44 may be an interactive display. In yet another embodiment, keyboard display 44 may display an image that is displayed on main display 16 or a complimentary image of the image displayed on main display 16.

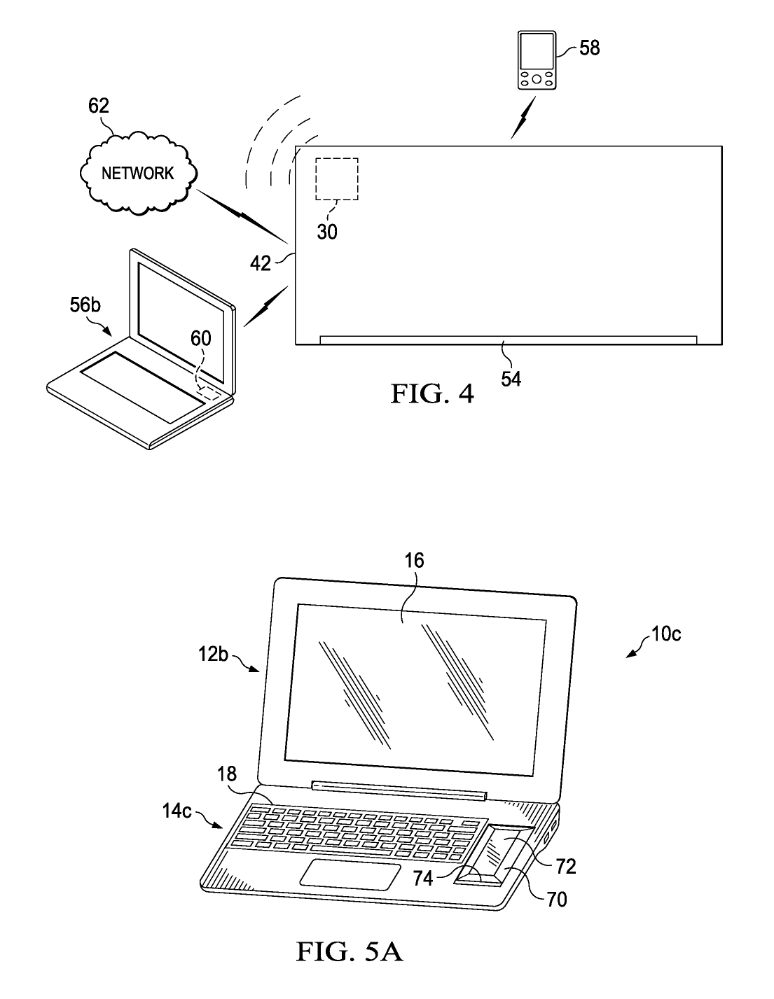

Turning to FIG. 4, FIG. 4 is a simplified block diagram illustrating an embodiment of electronic device 10b in accordance with one embodiment of the present disclosure. Detachable keyboard unit 42 may include detachable keyboard unit interconnect 54 and wireless module 30. Wireless module 30 (e.g., Wi-Fi module, Bluetooth module, WiDi module, etc.) allows detachable keyboard unit 42 to communicate with base device 56b when detachable keyboard unit 42 is removed from keyboard portion 14b. Wireless module 30 may also allow detachable keyboard unit 42 to communicate with network 62 and second electronic device 58 through a wireless connection.

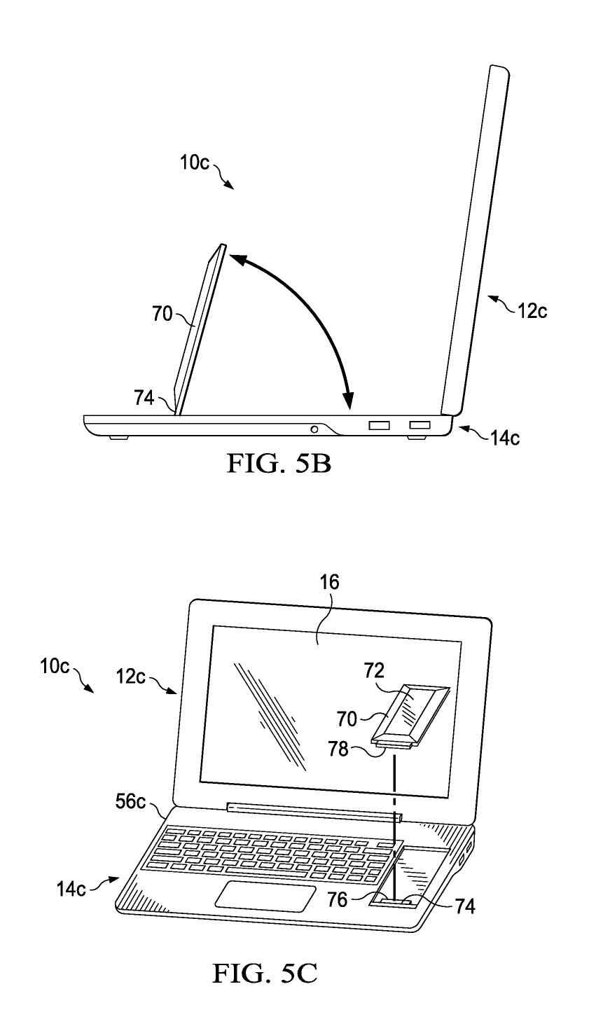

Turning to FIG. 5A, FIG. 5A is a simplified orthographic view illustrating an embodiment of an electronic device 10c in accordance with one embodiment of the present disclosure. Electronic device 10c may include display portion 12b and keyboard portion 14c. Keyboard portion 14c can include keyboard 18, a detachable touchscreen unit 70, and a touchscreen hinge 74. Touchscreen hinge 74 can define an axis of rotation that is shared between keyboard portion 14c and detachable touchscreen unit 70. Detachable touchscreen unit 70 may include a touchscreen display 72. Touchscreen display 72 can be a liquid crystal display (LCD), organic light-emitting diode (OLED), or some other type of display. Touchscreen display 72 may also be a touchscreen display. In another embodiment, detachable touchscreen unit 70 may contain a battery and various electronics (e.g., processor, memory, etc.) to allow detachable touchscreen unit 70 to operate as a standalone tablet. In an embodiment, when detachable touchscreen unit 70 is connected to keyboard portion 14c, touchscreen display 72 may function as a touch pad or display an interactive virtual keyboard or number pad.

Turning to FIG. 5B, FIG. 5B is a simplified orthographic view illustrating an embodiment of an electronic device 10c in accordance with one embodiment of the present disclosure. As illustrated in FIG. 5B, detachable touchscreen unit 70 has been rotated about touchscreen hinge 74 and away from keyboard portion 14c. Turning to FIG. 5C, FIG. 5C is a simplified schematic diagram illustrating an embodiment of electronic device 10c in a detach mode, separated into two segments. As illustrated in FIG. 5C, detachable touchscreen unit 70 has been separated from keyboard portion 14c, creating a base device 56c. Touchscreen hinge 74 may include a keyboard touchscreen interconnect 76. Detachable touchscreen unit 70 may include a detachable touchscreen unit interconnect 78. Keyboard touchscreen interconnect 76 may be a PCB interconnector.

Using keyboard touchscreen interconnect 76, an electrical current and signals can be passed between keyboard portion 14c and detachable touchscreen unit 70 to recharge an on-board battery or capacitor, power any number of items (e.g., touchscreen display 72, a wireless module, a camera, speakers, etc.), and provide a communication path between keyboard portion 14c and detachable touchscreen unit 70. In other examples, electrical current and signals can be passed through a plug-in connector (e.g., whose male side protrusion connects to keyboard portion 14c and whose female side connects to detachable touchscreen unit 70 or vice-verse) or a wireless connector (e.g., WiFi, Bluetooth, WiDi, etc.).

In one or more embodiments, when detachable touchscreen unit 70 is removed from keyboard portion 14c, detachable touchscreen unit 70 can function as a computer (e.g., notebook computer, laptop, tablet computer or device), a phablet, a cellphone, a personal digital assistant (PDA), a smartphone, an audio system, a movie player of any type, or other device that includes a circuit board coupled to a plurality of electronic components (which includes any type of components, elements, circuitry, etc.). Detachable touchscreen unit 70 can include a battery and various electronics (e.g., processor, memory, etc.) to allow detachable touchscreen unit 70 to function as a standalone device. In yet another embodiment, detachable touchscreen unit 70 may include a camera, a microphone, and speakers. When detachable touchscreen unit 70 is removed from keyboard portion 14c, touchscreen display 72 may function as a touch pad or display an interactive virtual keyboard or number pad. In another embodiment, when detachable touchscreen unit 70 is removed from keyboard portion 14c, detachable touchscreen unit 70 may function as a standalone tablet and touchscreen display 72 may be an interactive display. In another embodiment, detachable touchscreen unit 70 may display images that are displayed on main display 16 or images that are complimentary to images displayed on main display 16.

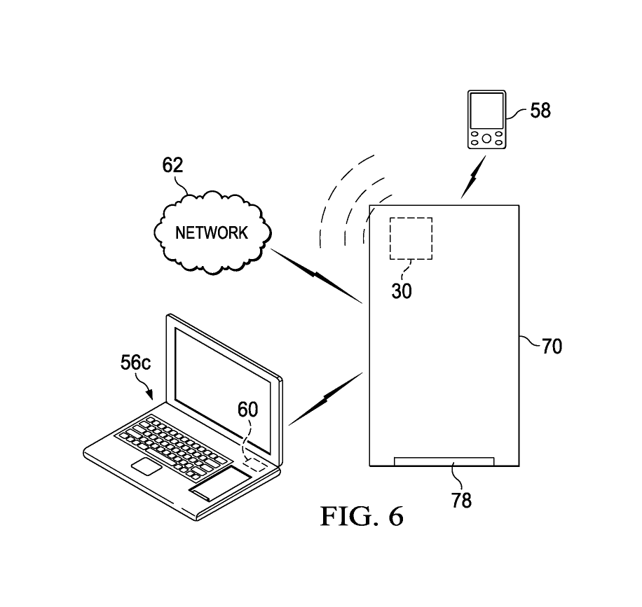

Turning to FIG. 6, FIG. 6 is a simplified block diagram illustrating an embodiment of electronic device 10c in accordance with one embodiment of the present disclosure. Detachable touchscreen unit 70 may include detachable touchscreen unit interconnect 78 and wireless module 30. Wireless module 30 (e.g., Wi-Fi module, Bluetooth module, WiDi module, etc.) allows detachable touchscreen unit 70 to communicate with base device 56c when detachable touchscreen unit 70 is removed from keyboard portion 14c. Wireless module 30 may also allow detachable touchscreen unit 70 to communicate with network 62 and second electronic device 58. While secondary display unit 20, detachable keyboard unit 42, and detachable touchscreen unit 70 have been shown having a specific size and shape, other embodiments of secondary display unit 20, detachable keyboard unit 42, and detachable touchscreen unit 70 can include any suitable dimensions, sizes, and shapes: all of which are encompassed by the present disclosure.

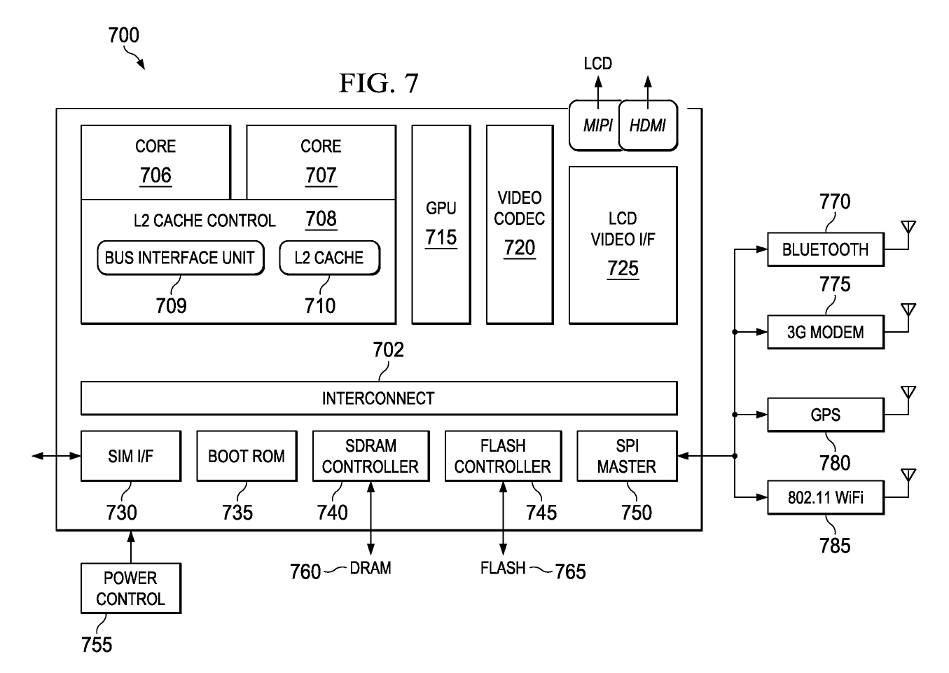

FIG. 7 is a simplified block diagram associated with an example ARM ecosystem SOC 700 of the present disclosure. At least one example implementation of the present disclosure can include the detachable unit features discussed herein and an ARM component. For example, the example of FIG. 7 can be associated with any ARM core (e.g., A-9, A-15, etc.). Further, the architecture can be part of any type of tablet, smartphone (inclusive of Android™ phones, i-Phones™), i-Pad™, Google Nexus™, Microsoft Surface™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LDC.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more example embodiment include one or more communication capabilities, interfaces, and features such as instances of Bluetooth™ 770, a 3G modem 775, a global positioning system (GPS) 780, and an 802.11 WiFi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

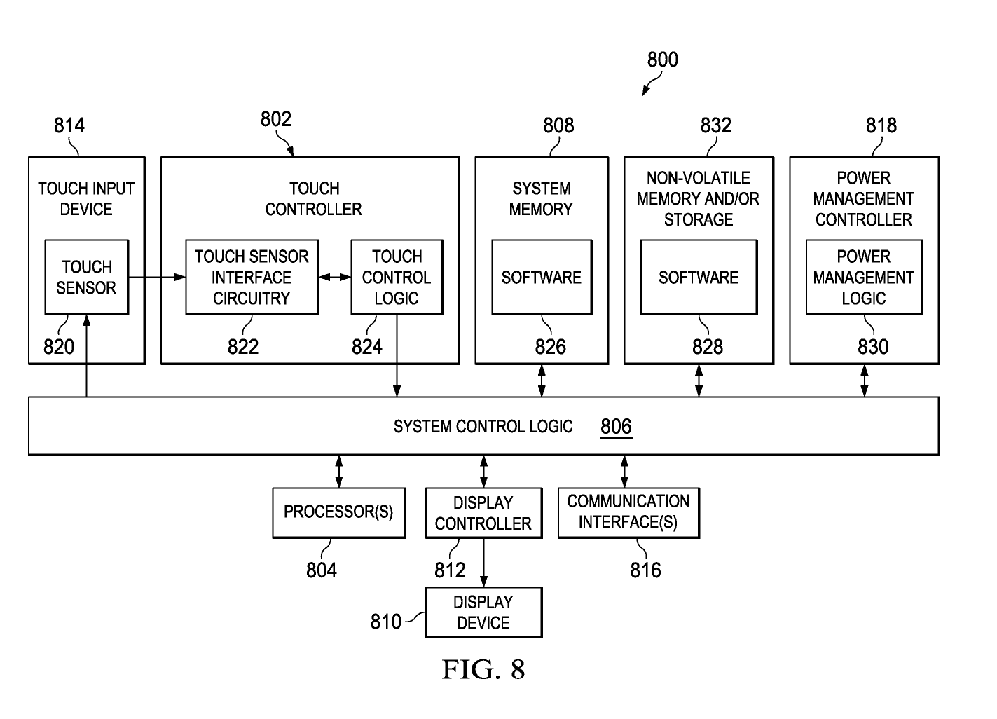

FIG. 8 is a simplified block diagram illustrating potential electronics and logic that may be associated with electronic device 10a, 10b, or 10c discussed herein. In at least one example embodiment, system 800 can include a touch controller 802, one or more processors 804, system control logic 806 coupled to at least one of processor(s) 804, system memory 808 coupled to system control logic 806, non-volatile memory and/or storage device(s) 832 coupled to system control logic 806, display controller 812 coupled to system control logic 806, display controller 812 coupled to a display device 810, power management controller 818 coupled to system control logic 806, and/or communication interfaces 816 coupled to system control logic 806.

Hence, the basic building blocks of any computer system (e.g., processor, memory, I/O, display, etc.) can be used in conjunction with the teachings of the present disclosure. Certain components could be discrete or integrated into a System on Chip (SoC). Some general system implementations can include certain types of form factors in which system 800 is part of a more generalized enclosure. In alternate implementations, instead of notebook device/laptops, etc., certain alternate embodiments deal with mobile phones, tablet devices, etc.

System control logic 806, in at least one embodiment, can include any suitable interface controllers to provide for any suitable interface to at least one processor 804 and/or to any suitable device or component in communication with system control logic 806. System control logic 806, in at least one embodiment, can include one or more memory controllers to provide an interface to system memory 808. System memory 808 may be used to load and store data and/or instructions, for example, for system 800. System memory 808, in at least one embodiment, can include any suitable volatile memory, such as suitable dynamic random access memory (DRAM) for example. System control logic 806, in at least one embodiment, can include one or more I/O controllers to provide an interface to display device 810, touch controller 802, and non-volatile memory and/or storage device(s) 832.

Non-volatile memory and/or storage device(s) 832 may be used to store data and/or instructions, for example within software 828. Non-volatile memory and/or storage device(s) 832 may include any suitable non-volatile memory, such as flash memory for example, and/or may include any suitable non-volatile storage device(s), such as one or more hard disc drives (HDDs), one or more compact disc (CD) drives, and/or one or more digital versatile disc (DVD) drives for example.

Power management controller 818 may include power management logic 830 configured to control various power management and/or power saving functions. In at least one example embodiment, power management controller 818 is configured to reduce the power consumption of components or devices of system 800 that may either be operated at reduced power or turned off when the electronic device is in a closed configuration. For example, in at least one embodiment, when the electronic device is in a closed configuration, power management controller 818 performs one or more of the following: power down the unused portion of the display and/or any backlight associated therewith; allow one or more of processor(s) 804 to go to a lower power state if less computing power is required in the closed configuration; and shutdown any devices and/or components that are unused when an electronic device is in the closed configuration.

Communications interface(s) 816 may provide an interface for system 800 to communicate over one or more networks and/or with any other suitable device. Communications interface(s) 816 may include any suitable hardware and/or firmware. Communications interface(s) 816, in at least one example embodiment, may include, for example, a network adapter, a wireless network adapter, a telephone modem, and/or a wireless modem. System control logic 806, in at least one embodiment, can include one or more I/O controllers to provide an interface to any suitable input/output device(s) such as, for example, an audio device to help convert sound into corresponding digital signals and/or to help convert digital signals into corresponding sound, a camera, a camcorder, a printer, and/or a scanner.

For at least one embodiment, at least one processor 804 may be packaged together with logic for one or more controllers of system control logic 806. In at least one embodiment, at least one processor 804 may be packaged together with logic for one or more controllers of system control logic 806 to form a System in Package (SiP). In at least one embodiment, at least one processor 804 may be integrated on the same die with logic for one or more controllers of system control logic 806. For at least one embodiment, at least one processor 804 may be integrated on the same die with logic for one or more controllers of system control logic 806 to form a System on Chip (SoC).

For touch control, touch controller 802 may include touch sensor interface circuitry 822 and touch control logic 824. Touch sensor interface circuitry 822 may be coupled to detect touch input over a first touch surface layer and a second touch surface layer of a display (i.e., display device 810). Touch sensor interface circuitry 822 may include any suitable circuitry that may depend, for example, at least in part on the touch-sensitive technology used for a touch input device. Touch sensor interface circuitry 822, in one embodiment, may support any suitable multi-touch technology. Touch sensor interface circuitry 822, in at least one embodiment, can include any suitable circuitry to convert analog signals corresponding to a first touch surface layer and a second surface layer into any suitable digital touch input data. Suitable digital touch input data for at least one embodiment may include, for example, touch location or coordinate data.

Touch control logic 824 may be coupled to help control touch sensor interface circuitry 822 in any suitable manner to detect touch input over a first touch surface layer and a second touch surface layer. Touch control logic 824 for at least one example embodiment may also be coupled to output in any suitable manner digital touch input data corresponding to touch input detected by touch sensor interface circuitry 822. Touch control logic 824 may be implemented using any suitable logic, including any suitable hardware, firmware, and/or software logic (e.g., non-transitory tangible media), that may depend, for example, at least in part on the circuitry used for touch sensor interface circuitry 822. Touch control logic 824 for at least one embodiment may support any suitable multi-touch technology.

Touch control logic 824 may be coupled to output digital touch input data to system control logic 806 and/or at least one processor 804 for processing. At least one processor 804 for at least one embodiment may execute any suitable software to process digital touch input data output from touch control logic 824. Suitable software may include, for example, any suitable driver software and/or any suitable application software. As illustrated in FIG. 8, system memory 808 may store suitable software 826 and/or non-volatile memory and/or storage device(s).

Note that in some example implementations, the functions outlined herein may be implemented in conjunction with logic that is encoded in one or more tangible, non-transitory media (e.g., embedded logic provided in an application-specific integrated circuit (ASIC), in digital signal processor (DSP) instructions, software [potentially inclusive of object code and source code] to be executed by a processor, or other similar machine, etc.). In some of these instances, memory elements can store data used for the operations described herein. This can include the memory elements being able to store software, logic, code, or processor instructions that are executed to carry out the activities described herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), a DSP, an erasable programmable read only memory (EPROM), electrically erasable programmable read-only memory (EEPROM)) or an ASIC that can include digital logic, software, code, electronic instructions, or any suitable combination thereof.

It is imperative to note that all of the specifications, dimensions, and relationships outlined herein (e.g., height, width, length, materials, etc.) have only been offered for purposes of example and teaching only. Each of these data may be varied considerably without departing from the spirit of the present disclosure, or the scope of the appended claims. The specifications apply only to one non-limiting example and, accordingly, they should be construed as such. In the foregoing description, example embodiments have been described. Various modifications and changes may be made to such embodiments without departing from the scope of the appended claims. The description and drawings are, accordingly, to be regarded in an illustrative rather than a restrictive sense.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Example Embodiment Implementations

Particular embodiments described herein provide for an electronic device, such as a notebook computer, laptop, or tablet that includes a circuit board coupled to a plurality of electronic components (which may include any type of components, elements, circuitry, etc.). One particular example implementation of an electronic device may include a display portion, which includes a main display that is provided on a first side of the display portion; a secondary display unit that is provided on a second side of the display portion; and a hinge to secure the secondary display unit to the display portion, where the hinge is to allow a rotation of the secondary display unit in relation to the display portion.

In certain embodiments, the electronic device is configured to operate in a closed clamshell configuration in which the main display is not accessible and the secondary display unit is accessible. The secondary display unit can be configured for detachment from the display portion. The secondary display unit can operate as a standalone tablet when detached from the display portion. In other embodiments, the secondary display unit includes wireless communication circuitry, and the secondary display unit is configured to communicate with the display portion using the wireless communication circuitry when detached from the display portion. In yet other embodiments, the secondary display unit displays an image that is also provided on the main display. In at least one embodiment, the hinge includes an interconnect for transmitting a plurality of electrical signals, and the secondary display unit is connected to the display portion through the interconnect.

What is claimed is:

1. An electronic device, comprising:
a display portion, which includes a main display that is provided on a first side of the display portion;
a secondary display unit that is provided on a second side of the display portion; and
a hinge to secure the secondary display unit to the display portion, wherein the hinge is to allow a rotation of the secondary display unit in relation to the display portion.

2. The electronic device of claim 1, wherein the electronic device is configured to operate in a closed configuration in which the main display is not accessible and the secondary display unit is accessible.

3. The electronic device of claim 1, wherein the secondary display unit is configured for detachment from the display portion.

4. The electronic device of claim 3, wherein the secondary display unit operates as a standalone tablet when detached from the display portion.

5. The electronic device of claim 4, wherein the secondary display unit includes wireless communication circuitry, and wherein the secondary display unit is configured to communicate with the display portion using the wireless communication circuitry when detached from the display portion.

6. The electronic device of claim 1, wherein the secondary display unit displays an image that is also provided on the main display.

7. The electronic device of claim 1, wherein the secondary display unit includes a touchscreen.

8. The electronic device of claim 1, wherein the hinge includes an interconnect for transmitting a plurality of electrical signals, and wherein the secondary display unit is connected to the display portion through the interconnect.

9. An electronic device, comprising:
a display portion, which includes a main display that is provided on a first side of the display portion; and
a secondary display unit that is provided on a second side of the display portion, wherein the secondary display unit is configured to be detached from the display portion such that it can perform at least one computing operation independent from the display portion.

10. The electronic device of claim 9, wherein the secondary display unit is an interactive virtual keyboard.

11. The electronic device of claim 9, further comprising:
a keyboard portion coupled to the display portion through a hinge, wherein the keyboard portion includes a keyboard.

12. The electronic device of claim 9, wherein the secondary display unit is a standalone tablet when detached from the display portion.

13. The electronic device of claim 9, wherein the secondary display unit includes wireless communication circuitry for communicating with the electronic device when the secondary display unit is detached.

14. The electronic device of claim 9, further comprising:
a hinge to secure the secondary display unit to the display portion, wherein the hinge is to allow a rotation of the secondary display unit in relation to the display portion.

15. The electronic device of claim 14, wherein the hinge is configured to react to a downward force on at least a portion of the secondary display unit by raising the secondary display unit to a certain angle with respect to the display portion.

16. A method, comprising:
receiving a secondary display unit at an electronic device that includes a display portion, wherein the display portion includes a main display that is provided on a first side of the display portion, and wherein the secondary display unit is provided on a second side of the display portion; and
rotating the secondary display unit via a hinge, which is to secure the secondary display unit to the display portion, wherein the hinge is to allow a rotation of the secondary display unit in relation to the display portion.

17. The method of claim 16, wherein the electronic device is configured to operate in a closed configuration in which the main display is not accessible and the secondary display unit is accessible.

18. The method of claim 16, wherein the secondary display unit is configured for detachment from the display portion.

19. The method of claim 16, wherein the secondary display unit operates as a standalone tablet when detached from the display portion.

20. The method of claim 16, wherein the secondary display unit includes wireless communication circuitry, and wherein the secondary display unit is configured to communicate with the display portion using the wireless communication circuitry when detached from the display portion.

21. A system, comprising:
means for receiving a secondary display unit at an electronic device that includes a display portion, wherein the display portion includes a main display that is provided on a first side of the display portion, and wherein the secondary display unit is provided on a second side of the display portion; and
means for rotating the secondary display unit that secures the secondary display unit to the display portion, wherein the secondary display unit rotates in relation to the display portion.

22. The system of claim 21, wherein the electronic device is configured to operate in a closed configuration in which the main display is not accessible and the secondary display unit is accessible.

23. The system of claim 21, wherein the secondary display unit is configured for detachment from the display portion.

24. The system of claim 21, wherein the secondary display unit operates as a standalone tablet when detached from the display portion.

25. The system of claim 21, wherein the secondary display unit includes wireless communication circuitry, and wherein the secondary display unit is configured to communicate with the display portion using the wireless communication circuitry when detached from the display portion.
